(19) United States
(12) Patent Application Publication
(10) Pub. No.: US 2015/0233353 A1
(43) Pub. Date: Aug. 20, 2015

(54) VERTICAL AXIS WIND TURBINE

(71) Applicant: ADVANCE WINDPOWER LTD, Blantyre, Glasgow, Strathclyde (GB)

(72) Inventor: Joseph Bertony, New South Wales (AU)

(21) Appl. No.: 14/425,381

(22) PCT Filed: Aug. 30, 2013
(86) PCT No.: PCT/GB2013/052288

§ 371 Date: Mar. 3, 2015

(30) Foreign Application Priority Data
Sep. 3, 2012 (AU) 2012903810

(51) Int. Cl. F03D 7/06; F03D 11/02; F03D 9/00; F03D 3/00; F03D 3/02

(52) U.S. Cl. CPC F03D 7/06; F03D 3/005; F03D 3/02; F03D 9/002; F03D 11/02

(57) ABSTRACT

A toroidal vertical axis wind turbine apparatus (10) has a shaft (14) vertically mounted in a support (12) providing for rotation of the vertically mounted shaft (14) about its longitudinal axis, and a plurality of vertically oriented elongate turbine blades (16), each vertically oriented elongate turbine blade (16) having a length and a width, and a length-wise warp which extends along at least a substantial part of the length of the turbine blade (16), wherein each vertically oriented elongate turbine blade (16) is mounted upon the vertically mounted shaft (14) by support arms (18) such that the vertically oriented elongate turbine blades (16) are mutually spaced and outwardly spaced from the vertically mounted shaft (14) such that when contacted by wind, the plurality of vertically oriented elongate turbine blades (16) move around a toroidal path and cause axial rotation of the vertically mounted shaft.

### BACKGROUND

The present disclosure relates to renewable energy apparatuses and more particularly relates to wind turbines for electricity generation.

Worldwide there is a trend towards use and development of renewable energy sources. The global trend is to break the cycle of dependency on oil based energy in favour of non-polluting renewable energy sources which are relatively economic, efficient, and naturally occurring.

One viable alternative energy source is wind. Wind is present as a source of renewable energy in most geographical locations of the world. In recent times, environmental concerns have driven investment into technological advancements in wind turbine technology especially in relation to large commercial wind turbines. Commercial wind turbines are usually sited together on so called “wind farms” throughout the world. These wind farms produce electricity which is normally intended to be introduced to the national electricity grid for commercial purposes.

Typically, these wind farms include high profile structures that comprise large towers that extend upwardly from the ground. At the top of each such tower, there is mounted a horizontal axis turbine. Such a horizontal axis turbine comprises a horizontally disposed shaft which is turned by a multiple blade rotor hub according to prevailing wind conditions and in parallel to received wind direction. Typical commercial designs have two or three blade rotors and the pitch of the blades may be variable. The rotor shaft turns relatively slowly in comparison with the required speed for efficient electricity generation. Therefore, the rotor shaft is generally coupled to a transmission system including gearing to step up the output rotational speed. The presence of a gearbox has been exposed as a weakness of large horizontal axis wind turbines in that service life is limited by the reliability of the gearbox. Furthermore, the horizontal axis turbine may have a limited operational wind speed range, requiring it to be braked or locked against rotation when wind speed limits are likely to be exceeded in order to avoid damage to the gearbox. Furthermore, scaling up horizontal axis wind turbines may lead to mass management issues.

Global demand for electricity is increasing not only in the developed countries, but also to address the anticipated energy needs of many millions of people in the developing third world. The current trend has been to focus on generation of electricity at a relatively small number of sites with transmission and distribution of electricity to consumers by an existing national grid or network of power lines. However, the load on such an energy infrastructure could be reduced if individual consumers or a small group of consumers had the means to be self-sufficient with respect to their power needs. At present achieving self-sufficiency is expensive and relies on consumers to adopt solar power or traditional petroleum based fuel driven generators. In time, self-sufficiency will be embraced by consumers but only when it is economic to do so or some other imperative dictates the need for self-sufficiency such as absence of supply when recoverable hydrocarbon resources are exhausted for example. The burning of fossil fuels is no longer a viable or desirable long term option. However the costs involved in the change of infrastructure required to deliver and to transport power is beyond many countries financial capabilities over the short and medium term. Therefore, there continues to be a foreseeable need of an alternative means for generating power.

An object of the present disclosure is to provide an improved design of wind-driven machine capable of being utilised in the generation of electricity. The wind-driven machine to be disclosed herein may be used to transform rotational motion into other useful work by suitable coupling to a power take off shaft, optionally through a power transmission system. Thus the wind-driven machine disclosed herein may be used to drive a fluid pump, or an electrical generator for example.

### SUMMARY

Turbine blades of a novel design for use in wind turbines are disclosed herein. This disclosure further relates to a wind turbine, embodiments of which mount a plurality of the novel turbine blades in a manner which improves the efficiency of capture of the wind power, and which may be referred to as a toroidal vertical axis wind turbine. This disclosure further relates to an improved efficiency vertical axis wind turbine assembly which is controllable according to sensed performance under wind and load conditions.

The present invention as defined in the claims provides an alternative prime mover to the known renewable energy apparatuses and particularly an improvement over known wind-powered generators. Embodiments of the invention provide a wind turbine having turbine blades which interact with wind to improve efficiency of the generator output at substantially all points of rotation.

According to an aspect, there is disclosed an apparatus comprising a shaft mounted vertically in a support providing for axial rotation of the vertically mounted shaft, and a plurality of vertically oriented elongate turbine blades mounted upon the vertical shaft, each turbine blade having a length between opposite free ends, and a length-wise warp which extends along at least a substantial part of the length of the turbine blade between the opposite free ends, and wherein the turbine blade has a warp width between a leading edge and a trailing edge forming a turbine blade surface capable of creating a pressure differential in an air flow over the turbine blade surface.

The apparatus may have at least three vertically oriented elongate turbine blades. The apparatus may have five or more vertically oriented elongate turbine blades.

Each turbine blade may be mounted upon at least one arm attached directly or indirectly to the vertically mounted shaft. The use of the at least one arm allows the plurality of vertically oriented elongate turbine blades to be spaced from the vertically mounted shaft, such that in use the plurality of vertically oriented elongate turbine blades are capable of movement within a toroidal path around the vertically mounted shaft.

The at least one arm may be adjustable, for example by use of a linear actuator to retract the vertically oriented elongate turbine blades from a configuration allowing the toroidal path to be followed.

Thus in one aspect, the plurality of vertically oriented elongate turbine blades can be deployed by use of a linear actuator for wind capture in a toroidal path to provide a toroidal vertical axis wind turbine.

In embodiments, a retractable control arm may be obtained for example by including telescopic sections attached to mechanical, hydraulic, or electromechanical actuators.

A system controller may be used to synchronise the linear actuators to simultaneously move each turbine blade in a toroidal assembly of turbine blades inwardly or outwardly as required to provide uniform alignment or orientation adjustment to the vertical axis wind turbine blades in response to sensed wind conditions. For example in the case of exceptional high wind, such as cyclonic or hurricane conditions, the system controller in response to the sensed conditions, may activate the linear actuators to draw the turbine blades inwardly to limit input torque within tolerance for the conditions, or even to retract the toroidal configuration completely and shut the vertical axis wind turbine down until favourable wind conditions return. This can be entirely an automatic response to local sensor devices e.g. a torque monitor, or in response to a transmitted signal from a remote station when unfavourable weather conditions are predicted in the locality of the vertical axis wind turbine. In embodiments the system controller may selectively control individual linear actuators to balance the turbine blades in the toroidal assembly as they advance around wind quadrants about the vertically disposed rotatable drive shaft.

In embodiments the vertically mounted shaft may be connected to an epicyclic gear transmission allowing transfer of torque from the vertically mounted shaft to a device or a machine, such as for example, a fluid pump or an electrical generator. The epicyclic gear transmission may comprise an outer static ring gear within which a plurality of epicyclic (satellite) gears are arranged to drive a central (sun) gear. This arrangement is virtually silent, offering a significant environmental advantage over traditional horizontal axis wind turbines. Additionally, the use of an epicyclic gear transmission together with a torque sensor allows the use of the driving torque to be monitored and used to enable control of all operational parameters of the disclosed vertical axis wind turbine. It is possible to extend the active wind capture of the disclosed apparatus over a substantially wider range, say from wind speeds of only 2 m/s up to about 40 m/s instead of current ranges of from 6 m/s to 24 m/s.

These advantageous features offer a wind-powered machine which requires far less maintenance and which can be electronically controlled, for example remotely controlled. Furthermore, a larger annual power output is obtainable.

According to another aspect of the disclosure, there is provided a toroidal vertical axis wind turbine apparatus comprising a shaft vertically mounted in a support providing for rotation of the vertically mounted shaft about its longitudinal axis, and a plurality of vertically oriented elongate turbine blades, each vertically oriented elongate turbine blade having a length and a width, and a length-wise warp which extends along at least a substantial part of the length of the turbine blade, wherein each vertically oriented elongate turbine blade is mounted upon the vertically mounted shaft by support arms such that the vertically oriented elongate turbine blades are mutually spaced and outwardly spaced from the vertically mounted shaft such that when contacted by wind, the plurality of vertically oriented elongate turbine blades move around a toroidal path and cause axial rotation of the vertically mounted shaft.

The toroidal vertical axis wind turbine apparatus may incorporate any one or more of the features of other innovative aspects disclosed herein or as illustrated in the accompanying figures.

The present disclosure further relates to an improved efficiency vertical axis wind turbine capable of being deployed from a stowed configuration into an operational configuration providing a toroidal wind turbine other than by use of a linear actuator. In an embodiment each vertically oriented elongate turbine blade is mounted using a control arm of a fixed length, having first and second ends, wherein each control arm may be attached at the first end to a turbine blade which in use is to be positioned at the periphery of a toroidal assembly of such turbine blades, and pivotally connected at the second end to a centrally arranged hub, which hub may be selectively advanced through an arc of rotation to effect a simultaneous retraction of each turbine blade towards the hub.

In embodiments of a toroidal wind turbine, the plurality of vertically oriented elongate turbine blades may be mounted respectively by support arms attached to a rotatable sleeve coupled to the vertically mounted shaft. The vertically oriented elongate turbine blades may each be supported by more than one support arm.

Embodiments of a turbine blade to be used in assembly of a vertical axis wind turbine have a unique warped aerofoil shape. The turbine blade may be an elongate blade having a longitudinal axis, and in the intended use would be vertically oriented with its longitudinal axis aligned with a primary vertical axis of a rotatable vertically shaft. The turbine blades each may be generally arcuate shaped in cross section, to provide an aerofoil section. Each turbine blade may include a warp which extends along at least part of the length of the turbine blade, such that the angle of attack of the aerofoil section changes by degrees according to the extent of warp of the turbine blade. According to at least one embodiment the opposite ends of the turbine blades do not align, and are offset when the turbine blade is viewed along its longitudinal axis.

A trailing edge of the turbine blade may be extended by a flap which may be integrated with the turbine blade as a fixed extension of the turbine blade, or provided as a movable control surface.

A turbine blade in accordance with this disclosure may be formed by orienting one end relative to the other end in an offset relationship, for example a rotation of one end relative to the other end, such that the rotated end can be disposed in a new position relative to the other end within the range 30-180 degrees out of phase as viewed relative to a longitudinal axis through the turbine blade.

In embodiments of any aspect, the vertically arranged rotatable shaft may comprise an upright mast journaled in upper and lower bearing sets for rotation about a primary vertical axis. The upright mast may have a height above the upper bearing set which provides for mounting a plurality of turbine blades vertically in parallel to the primary vertical axis of the vertically arranged rotatable shaft. The mast may take the form of a hollow sleeve rotatable about the primary vertical axis. The hollow sleeve of the mast may have vertically spaced upper and lower flanges to mount vertically disposed turbine blades.

The mast may be operatively engaged with a gear box comprising a static ring gear, with a plurality of satellite gears engaged for rotation within the static ring gear, and with a central gear in engagement with the satellite gears.

A novel electrical power system may comprise a toroidal vertical axis wind turbine as disclosed herein and claimed, the vertical axis wind turbine being operatively connected with an electricity generator which is electrically connected with at least one of an inverter, electrical switchgear, electrical charge storage devices and a power grid.

Optionally, the vertical axis wind turbine may be operatively connected with a hydraulic pump, hydraulic pressure accumulators or reservoirs and one or more hydraulic motors. The hydraulic motors may be used to drive one or more electricity generators. DC to AC inverters and AC to DC converters may be utilised in conjunction with charge storage devices such as cells, batteries, capacitor based storage devices and accumulators.

The present invention provides an alternative to the known prior art and the identified shortcomings thereof. The advantages of the disclosed turbine blade and wind-powered apparatus incorporating same will appear from the illustrative description to follow. In the following specific description reference is made to the accompanying representations, which form a part of the disclosure. These representations show by way of illustration specific embodiments in which the invention may be practiced.

### BRIEF DESCRIPTION OF THE DRAWINGS

The present invention will now be described according to preferred but non limiting embodiments and with reference to the accompanying illustrations, wherein;

FIG. 1 is a perspective view of a vertical axis wind turbine apparatus according to one embodiment of the present invention;

FIG. 2 is a plan view of the vertical axis wind turbine apparatus of FIG. 1;

FIG. 3 is a side elevation view of the vertical axis wind turbine apparatus of FIG. 1;

FIG. 4 is a fragmentary vertical sectional view of a vertical axis wind turbine apparatus showing the rotatable vertical shaft of the vertical axis wind turbine apparatus;

FIG. 5 is a perspective view of a turbine blade for a vertical axis wind turbine apparatus;

FIG. 6 is an elevation view of a turbine blade showing a reinforcing structure utilized within the turbine blade;

FIG. 7 is an end elevation view of a turbine blade for a vertical axis wind turbine apparatus;

FIG. 8 shows a view from above a vertical axis wind turbine apparatus wherein the turbine blades are moveable using linear actuators provided on control arms;

FIG. 9 shows an enlarged schematic view of a wind turbine showing turbine blades at different positions with reference to corresponding radial support arms and relative to airflow during a 360 degree rotation about a vertical drive axis;

FIG. 10 shows an enlarged cross sectional view of a typical turbine blade according to one embodiment;

FIG. 11 shows schematically a toroidal wind generator located on a roof top indicating its relative size in comparison to a person;

FIG. 11a shows a plan view of the toroidal wind generator of FIG. 11;

FIG. 12 shows a horizontal wind generator superimposed over a vertical axis wind turbine apparatus to show the relative sizes of the wind tunnels which operate the horizontal and vertical wind generators respectively;

FIG. 13 shows a toroidal vertical axis wind turbine apparatus located in a maritime environment;

FIG. 13a shows a plan view of FIG. 13;

FIG. 14 shows a schematic view of a wind force regime about a toroidal wind turbine apparatus as contemplated in this disclosure;

FIG. 15 shows a turbine blade in finite element and demonstrating a helical warp;

FIGS. 16 and 17 respectively show first and second tables of results of operation of an embodiment of a toroidal wind turbine as contemplated in this disclosure;

FIG. 18 shows schematically and in successive illustrations, the differential pressure effect in airflow created by wind passing over a single turbine blade having a lengthwise warp as it advances around a toroidal path; and

FIG. 19 represents an optional hydraulic power transmission system for transmitting torque generated by the toroidal vertical axis wind turbine to multiple outputs; and

FIGS. 20a and 20b respectively illustrate in section and plan, an epicyclic gear transmission which may be coupled between a vertical axis turbine shaft and an output shaft.

Other aspects and advantages of the present invention will become apparent from consideration of the following description and the accompanying drawings which are merely illustrative and non-limiting upon the disclosure, the full scope of which is determined by the claims appended hereto.

### DETAILED DESCRIPTION OF EMBODIMENTS

In the drawings, a vertical axis wind turbine apparatus is shown therein and indicated generally by the numeral 10. The vertical axis wind turbine apparatus 10 is designed to be placed in the path of wind such that as the wind passes over and through the vertical axis wind turbine apparatus the wind will impinge upon a series of movable turbine blades attached to a vertically disposed rotatable shaft that will in turn drive, optionally through a power transmission system, a machine such as a generator operatively associated with the vertical axis wind turbine apparatus.

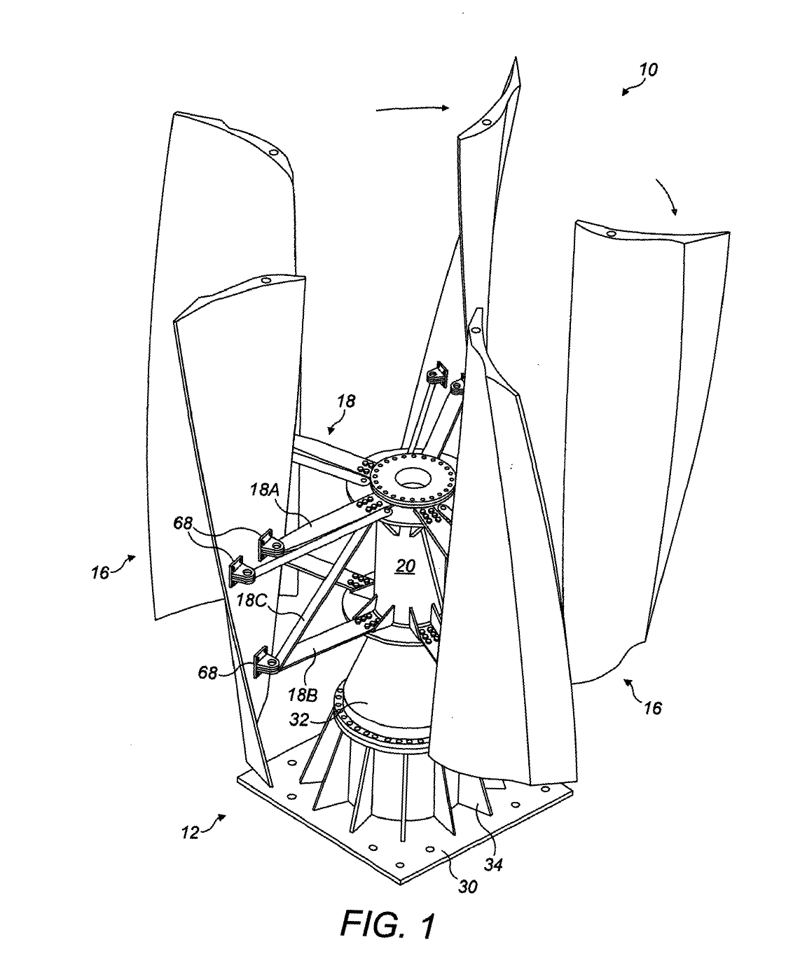

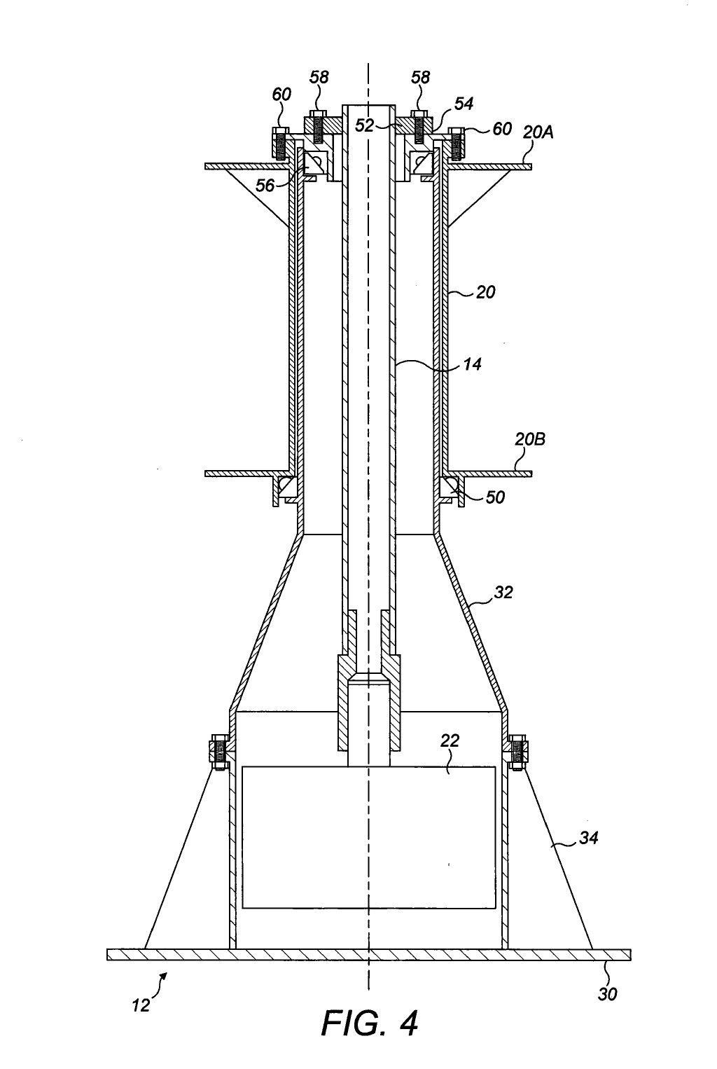

As shown in FIG. 1, vertical axis wind turbine apparatus 10 includes a main frame structure 12 and a rotatable drive shaft 14 mounted in the main frame structure 12. The rotatable drive shaft 14 is operatively connected with a generator 22 (see FIG. 4). Disposed about main frame 12 of turbine 10 is a series of turbine blades, 16. Rotatively mounted or journaled about the upper portion of the main frame structure 12 is a rotary sleeve 20. Rotary sleeve 20 is operatively connected to the rotatable drive shaft 14 such that as the rotary sleeve 20 is rotated, the rotary drive shaft 14 also rotates. Extending from the rotary sleeve 20 is a series of connecting arms 18 that respectively connect the rotary sleeve 20 to the plurality of turbine blades 16. The connecting arms include upper arms 18A, and lower arms 18B with optional, angled brace 18C. Optional brace 18C is shown extending diagonally from an inner end of upper arm 18A, downwardly to the outer end of lower arm 18B. The particular manner of connecting the rotary sleeve 20 with the respective turbine blades 16 will be discussed in greater detail below.

Main frame structure 12 includes a base plate 30. The base plate 30 covers a sufficient area that it is able to support the vertical axis wind turbine apparatus 10 in a stable configuration to withstand anticipated wind force. In some embodiments, or for some applications, the base plate 30 may be anchored by bolts or other suitable fastening means to an underlying support structure. Main frame structure 12 includes a multi-sectional housing 32 that extends upwardly from the base plate 30. A series of strengthening and stabilising buttress-like fins 34 are circumferentially disposed around the lower portion of the main frame 12.

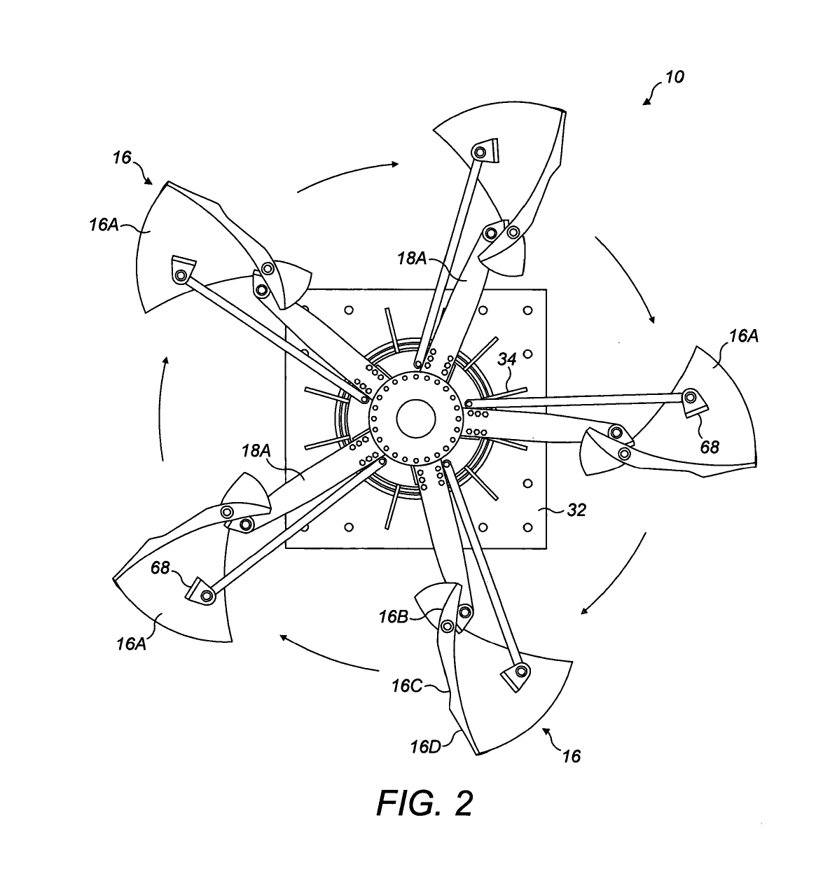

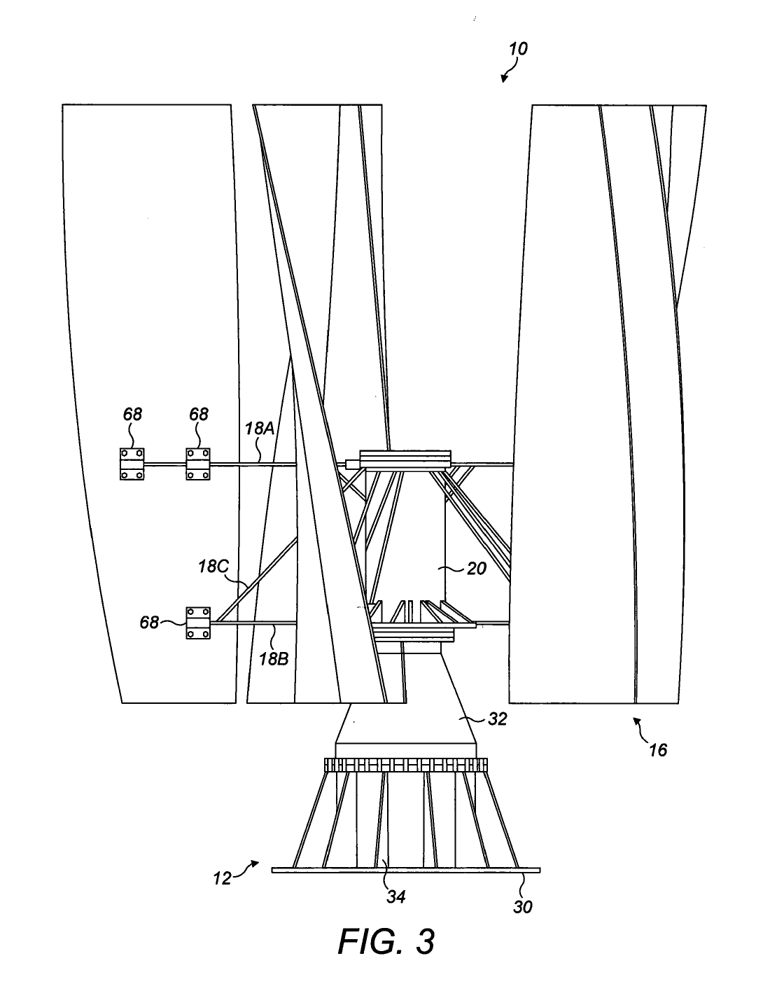

FIG. 2 is a plan view of the vertical axis wind turbine apparatus of FIG. 1, and FIG. 3 is a side elevation view of the vertical axis wind turbine apparatus of FIG. 1. Notably each of these figures illustrates the spacing of the turbine blades 16 from the rotary sleeve 20 and rotatable drive shaft 14. The spaced relationship is such that the turbine blades 16 are free to interact with wind received upon all surfaces of the turbine blades 16, which turbine blades 16 follow a toroidal path (shown by arrows in FIG. 2) driving around the rotary sleeve 20 and rotatable drive shaft 14. This provides a unique toroidal vertical axis wind turbine apparatus not disclosed in the known art.

Turning to a more detailed discussion of the rotary sleeve or housing 20, as represented in FIG. 4 the rotary sleeve 20 is rotatably mounted around the upper section or upper portion of the housing 32. The rotary sleeve 20 includes an upper annular flange 20A and a lower annular flange 20B. Bearings 50 lie under the lower flange 20B and provide a bearing support for the rotary sleeve 20. That is, as the rotary sleeve 20 rotates about the housing 32, bearings 50 support and facilitate this rotation.

Turning to FIG. 4, a plate 52 is shown secured to the upper portion of the shaft 14. Plate 52 is in turn secured to an annular bracket 54. As shown in FIG. 4, a series of bolts 58 extend downwardly through plate 52 into the annular bracket 54 and effectively couple the plate with the annular bracket. A second bearing assembly 56 is disposed adjacent the annular bracket 54, for example as illustrated in FIG. 4 where the second bearing assembly 56 is supported about an upper portion of a housing 32 in a position generally underneath the annular bracket 54. Thus as the shaft 14 is rotated, the annular bracket 14 is supported by the bearing assembly 56. The annular bracket 54 is in turn secured directly or indirectly to the rotary sleeve or housing 20. This may be accomplished by a series of bolts 60. Thus it will be appreciated that by rotatively driving the annular sleeve 20, that rotating motion is imparted to the annular bracket 54 which in turn drives the plate 52 which in turn drives the drive shaft 14.

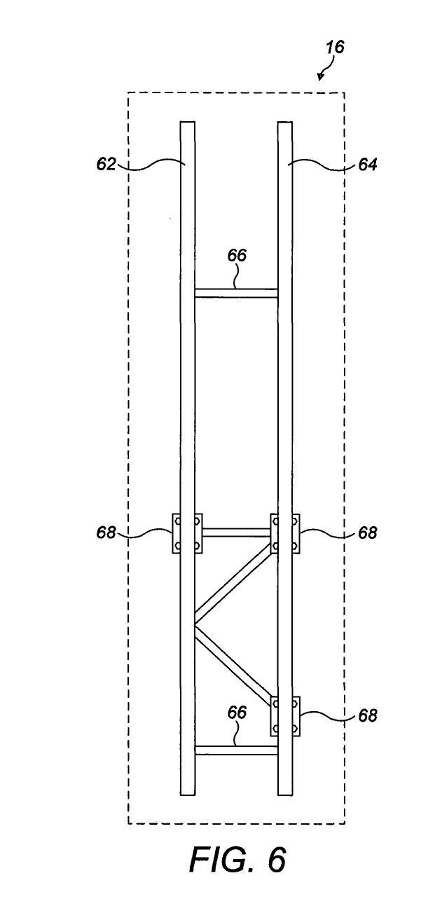

The turbine blades 16 are connected to the rotary sleeve 20 by a series of connecting arms 18A, 18B, and optional angled brace 18C. FIG. 1 illustrates that each turbine blade may include two connectors 56. For each turbine blade there may be provided an upper connecting arm 18A that extends from the upper flange 20A of the rotary sleeve 20 to an upper connector 68 affixed to the turbine blade 16. Likewise there may be a lower arm 18B that extends from the lower flange 20B to a lower connector 68 secured to the same turbine blade 16. In addition there may be a diagonal brace 18C, shown in FIG. 1, which may extend diagonally from the upper flange 20A of the rotary sleeve 20 to the lower connector 68. In the embodiment illustrated herein, each turbine blade 16 is provided with two connectors 68. It will be appreciated that more than two connectors can be utilized. In one embodiment, there may be provided three connectors 68 as shown in FIG. 6. In this case, there may be provided two upper connectors 68 and a lower connector 68. The turbine blades 16 may extend above the top of the shaft 14. In one design or embodiment, approximately two-thirds of the length or height of each turbine blade extends above the top of the shaft 14.

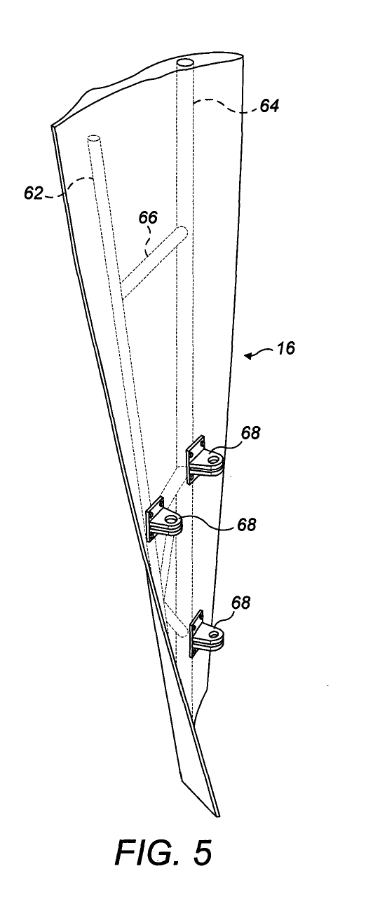

Referring to FIGS. 5, 6 and 7, there is shown therein details of the unique turbine blade 16 that forms a part of the vertical axis wind turbine apparatus 10. Each turbine blade 16 can be constructed of various materials but in the embodiment illustrated herein, each turbine blade is constructed of reinforced fiberglass. Embedded within the turbine blade 16 there is shown a reinforcing frame structure which may be of metal. In this case, as shown in FIGS. 5 to 7, the reinforced structure comprises a pair of metal rods 62 and 64 that are interconnected at various points by cross members 66. The connectors 68 discussed above are anchored to each turbine blade 16 at points that permit the connectors to be secured directly or indirectly to a portion of the reinforcing frame structure of the turbine blade 16.

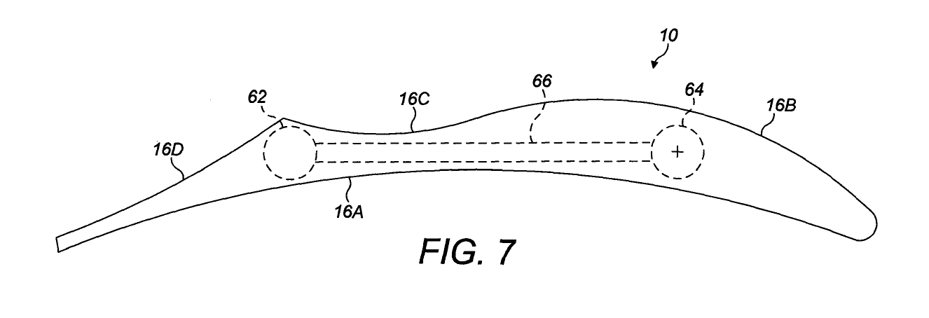

FIG. 7 illustrates the unique configuration of an embodiment of the turbine blade 16. First the turbine blade 16 includes a major concave surface 16A formed on one side of the turbine blade. This is illustrated in FIG. 7. On the opposite side of the turbine blade there is provided compound convex-concave surfaces. These surfaces include an outer convex surface 16B, an intermediate concave segment 16C, and an outer lesser concave segment 16D. FIG. 7 illustrates the general cross-sectional area or profile of an embodiment of the turbine blade 16.

As can be seen by referring back to FIG. 1, each turbine blade 16 has the profile of a warped aerofoil. Specifically, according to the invention, each vertically oriented elongate turbine blade 16 has a length and a width, and a length-wise warp which extends along at least a substantial part of the length of the turbine blade. The warp may be a helical warp extending throughout the length of the turbine blade.

When mounted on the vertical axis wind turbine apparatus 10, the opposite ends of the turbine blade 16 are mutually offset and appear warped relative to each other. In one application the opposite ends are offset approximately 50 to approximately 90 degrees with respect to each other. This is particularly illustrated in FIG. 2. In the particular embodiment illustrated in FIG. 2, the lower edge of the turbine blade 16 slightly trails the upper edge. The unique cross-sectional shape of the turbine blade 16 as shown in FIG. 7 coupled with the warp configuration just described provides a high efficiency wind turbine blade. The vertical warp, in one case or embodiment, is about 60°. This warp promotes secondary wind flow turbulence accelerating the wind flow within the toroidal volume enable by the presently disclosed vertical axis wind turbine apparatus.

The design of the turbine blade 16 enables the vertical axis wind turbine apparatus 10 under generator load to take advantage of a velocity pressure differential acting as “lift” and “drag”. As the wind impinges on turbine blades 16, the shape and configuration of the turbine blades is such as to function at times in a similar fashion to an airplane wing or aerofoil in that it is possible to generate “lift”. Lift imparts a force and this force enables the turbine blades 16 to be driven around the vertical axis of the drive shaft 14. Further, the general shape of the turbine blades 16 and the warped configuration enables the turbine blades 16 to take advantage of what may be referred to as “drag”. Here the wind, as schematically represented in FIG. 1, impinges on the trailing surfaces of the turbine blades 16 and this also causes the turbine blades 16 to be forced around the axis of the drive shaft 14. The vertical axis wind turbine apparatus in use assumes an expanded toroidal configuration to offer a vertical axis wind turbine apparatus wherein a multiple blade turbine rotates about an assumed theoretical vertical axis within and in response to the received wind flow. The turbine blades used in the presently disclosed vertical axis wind turbine apparatus may be alternatively and variously referred to by such terms as a wing blade, vane, impeller or aerofoil.

The vertical axis wind turbine apparatus does not need to be in an absolute vertical axis configuration to operate effectively. The vertical axis wind turbine apparatus can be set on an inclined slope to take full advantage of a particular topographic configuration.

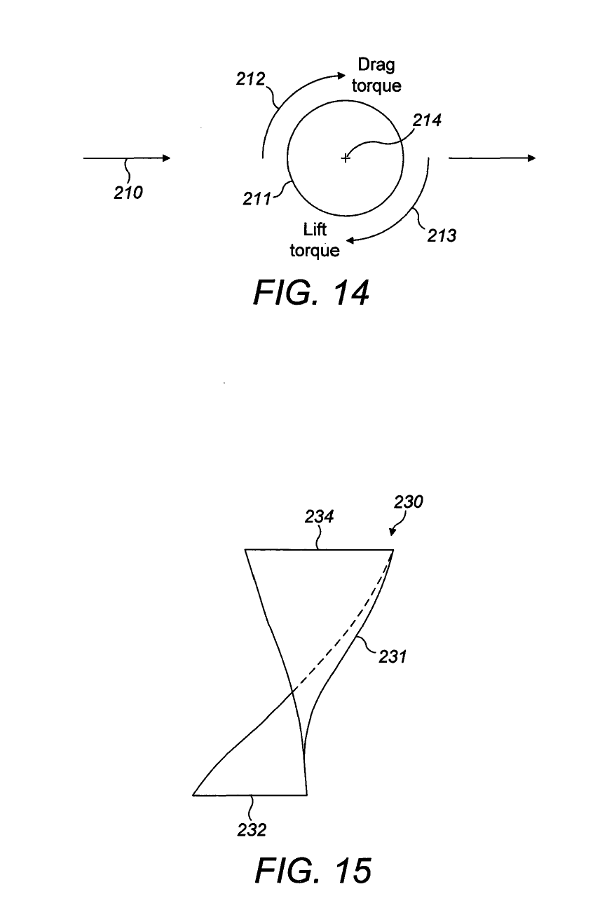

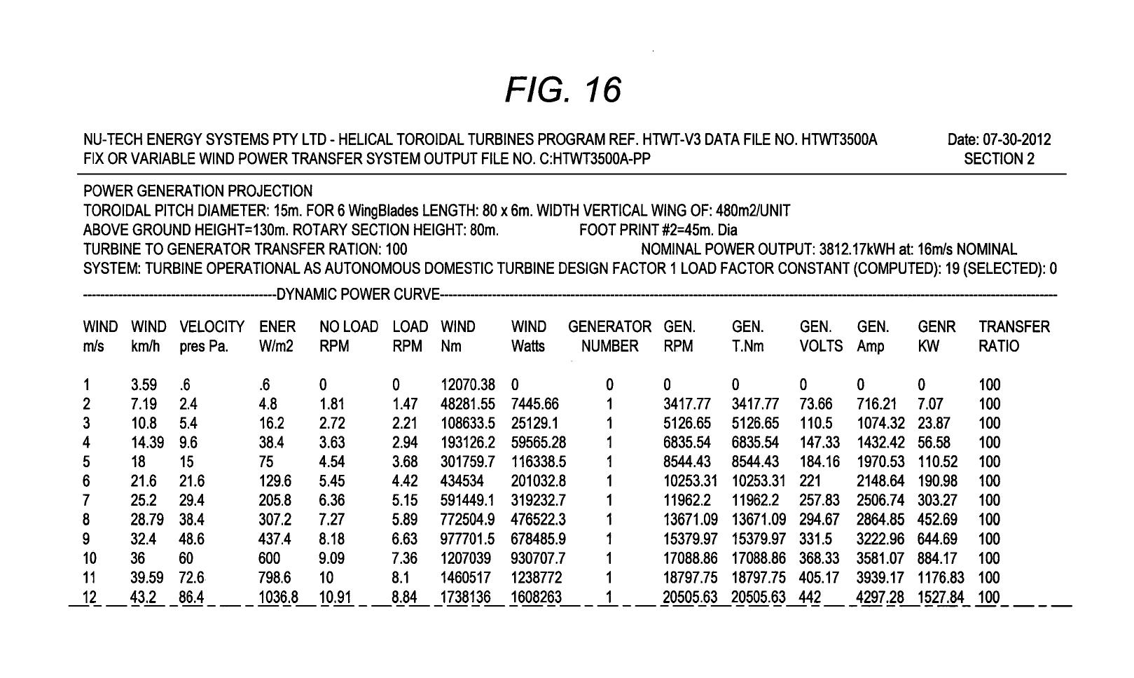

Equally, the vertical axis wind turbine apparatus may mounted on a floating offshore power generating platform (see FIG. 13), and yet be substantially unaffected in its operation by sea swell motions which have diminished effect due to the low centre of gravity of the vertical axis wind turbine apparatus.

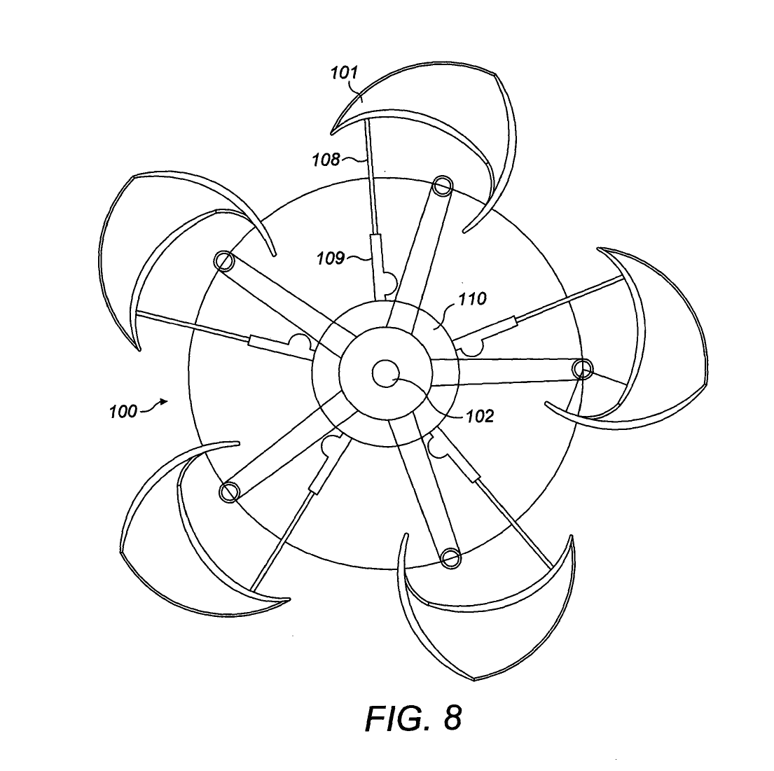

FIG. 8 shows a view from above a vertical axis wind turbine apparatus 100 according to a preferred embodiment wherein each turbine blade 101 is connected to a hub 110 or the like mounting near the vertical axis 102 by a control arm 108 which includes a linear actuator 109 for moving the turbine blade 101 inwardly towards the vertical axis 102.

Turbine blade 101 has a generally concave inner surface 105 which on the windward side captures wind by presenting a maximum surface area.

In an alternative embodiment the control arm has no linear actuator and instead the hub may be selectively advanced rotationally through an arc to provide for relative shortening of the spatial distance between the hub and the turbine blade so as to draw the turbine blade towards the hub by means of the control arm.

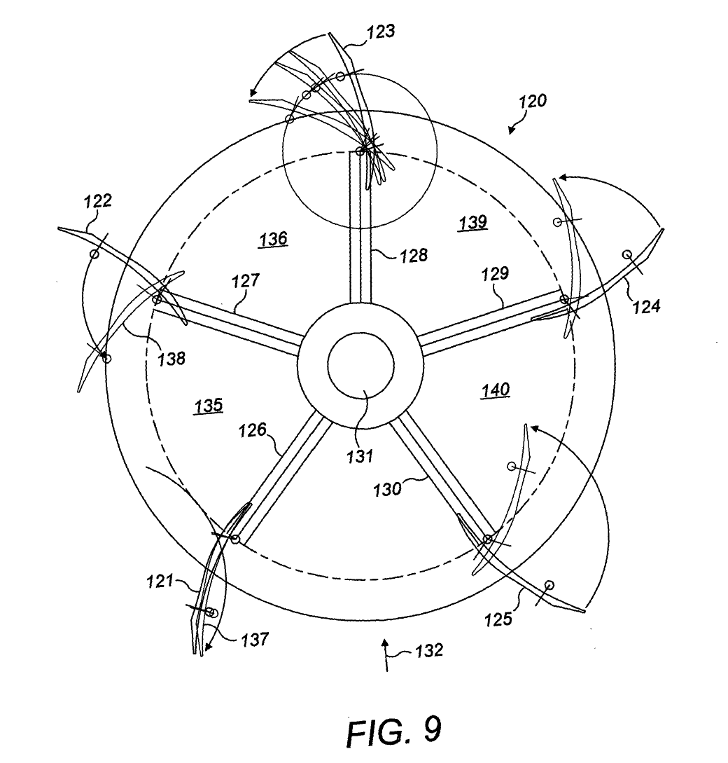

FIG. 9 shows a schematic plan view of a generator 120 showing turbine blades 121, 122, 123, 124 and 125 subtended from respective radial arms 126, 127, 128, 129 and 130 all rotating in unison about a drive shaft 131 but each turbine blade 121, 122, 123, 124 and 125 respectively being at a different orientation relative to airflow (arrow 132) during a 360 degree cycle of rotation about vertical drive shaft 131. In downwind quadrants 135 and 136 wind 132 is captured via respective turbine blade concave surfaces 137 and 138. As turbine blade 123 passes into quadrant 139 it presents its smallest dimension to wind creating least drag but still generating a lift force which urges the turbine blade into the upwind side through quadrants 139 and 140. The attitude of turbine blades 124 and 125 at upwind quadrant 139 and 140 locations creates one surface with a region of low pressure which urges the turbine blades upwind using similar principles to those observed in an aircraft wing or sailing boat sail.

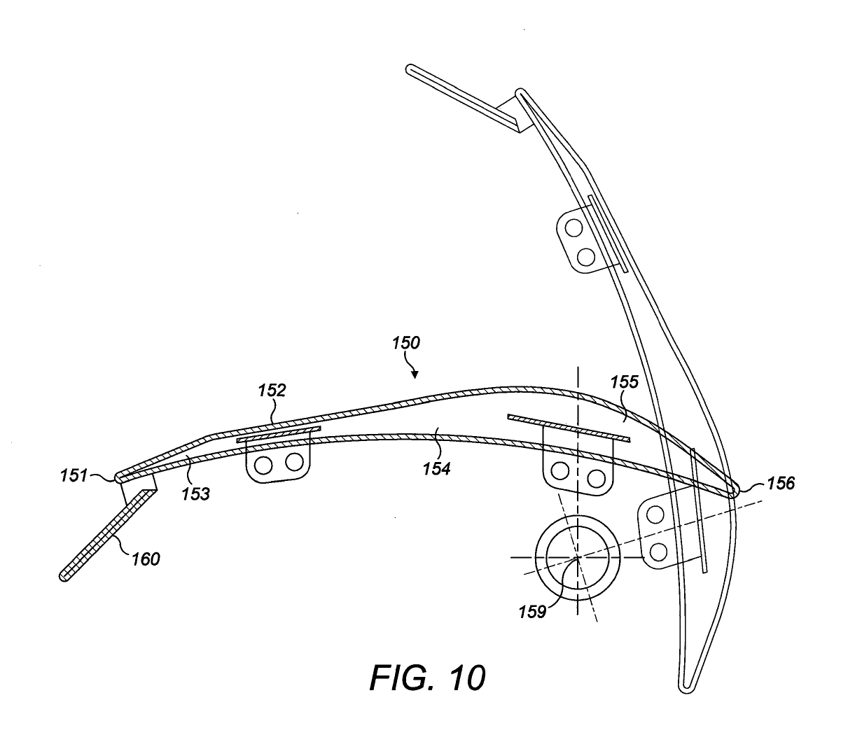

FIG. 10 shows an enlarged cross sectional view of a turbine blade 150 according to one embodiment. In that embodiment the profiled shape of each turbine blade when viewed in cross section or end view moving from a first edge 151 to a second edge 156 comprises a first outward tapered region 153 of a first size, a second tapered region 154 of a second size and a third inward taper 155 extending to said second edge 156. According to an embodiment, the second outward tapered region 154 may include a narrow section 152 over part of the length of the second taper.

Extending from the first edge 151 is a control surface 160 in the nature of a flap which aerodynamically assists the wind capture during rotation of the vertical axis wind turbine. According to one embodiment, each turbine blade is capable of rotation up to but can exceed 90 degrees about its secondary axis of rotation 159. Each turbine blade 150 may be retractably adjustable as the vertical axis wind turbine rotates for example using linear actuators incorporated in radial support arms which extend radially from the primary shaft of a vertical axis wind turbine.

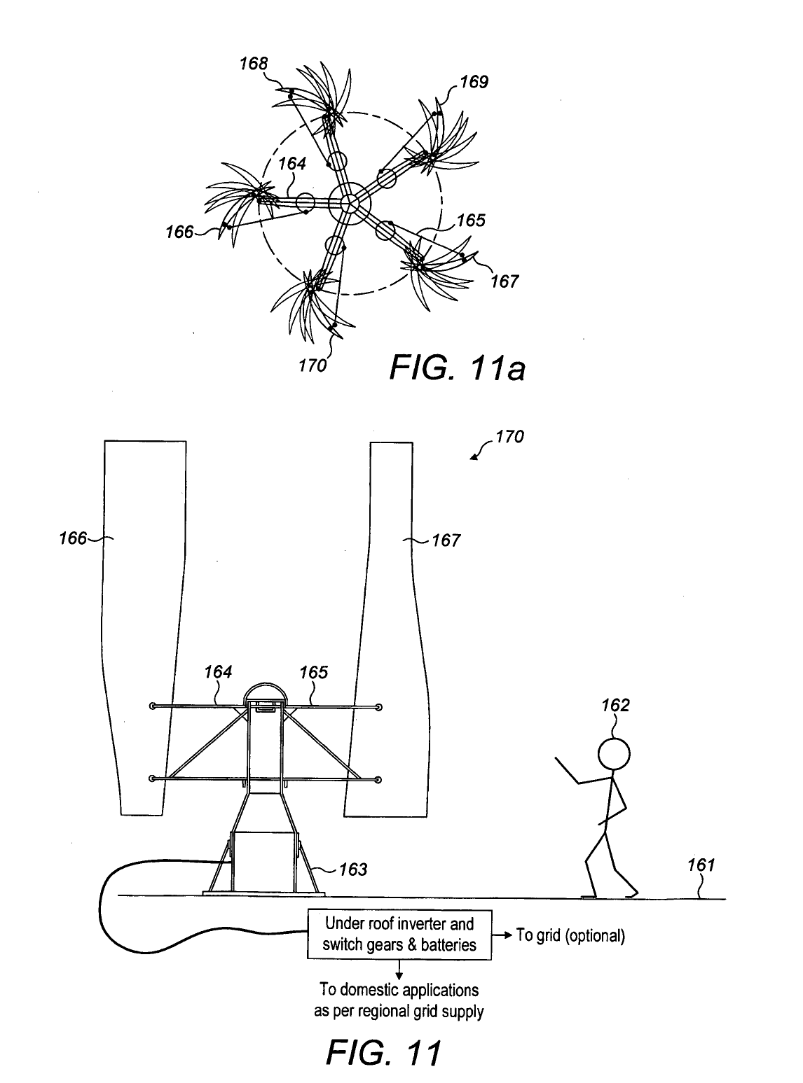

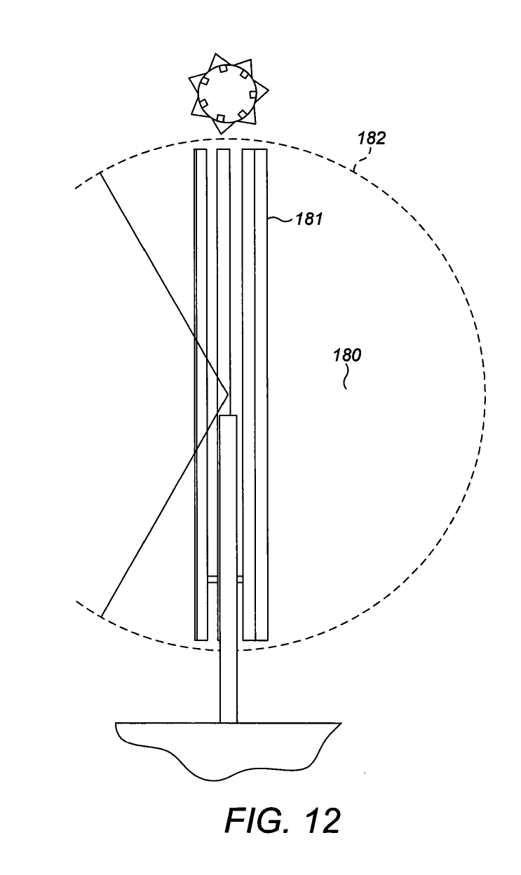

FIG. 11 illustrates schematically an assembled vertical axis wind turbine or toroidal wind generator 160 located on a roof top 161, and indicating its relative size in comparison to a person 162. Generator 160 includes a primary support 163 from which extend radial arms 164 and 165 retaining turbine blades 166 and 167. Plan view FIG. 11a shows turbine blades 166, 168, 169, 167 and 170. In this arrangement an under roof inverter and switch gears may be provided along with storage batteries. In this way the vertical axis wind turbine- or toroidal wind-powered electrical generator 160 may be connected via a single power cable to the inverter and switchgear and storage batteries to meet demand from domestic appliances or further connected to the external grid to deliver excess power generated to other users.

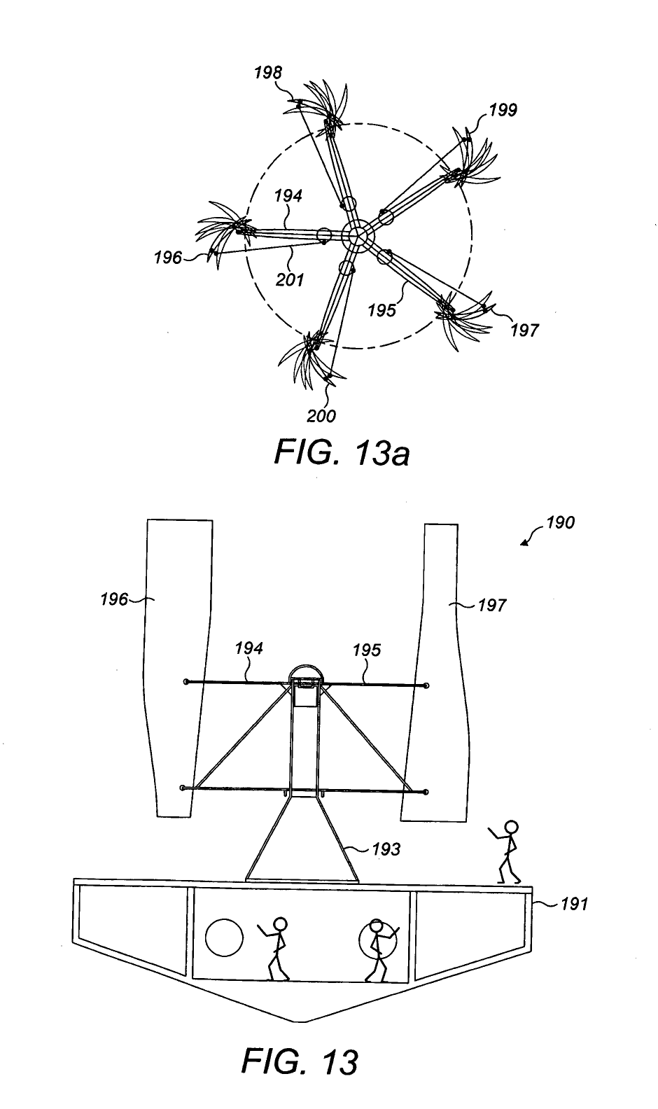

FIG. 12 shows a horizontal (propeller type) wind generator 180 superimposed over a vertical axis wind turbine generator 181 to show the relative sizes of the wind tunnels which operate the horizontal and vertical wind generators respectively. Circle 182 shows the large size of the wind tunnel which operates the horizontal wind turbine 180.

FIG. 13 shows a vertical axis wind turbine or toroidal wind generator assembly 190 located in a maritime environment. Generator 190 is represented as floating on a buoyant body 191 in water and includes a primary support 193 from which extends radial arms 194 and 195 retaining turbine blades 196 and 197. Plan view FIG. 13a shows the turbine blades 196, 197, in spaced relationship with further turbine blades 198, 199, and 200. Referring to turbine blade 196 by way of example, this may be mechanically adjusted (re-oriented) by a controller which actuates a mechanical or hydraulic arm 201.

The vertical axis wind turbine or toroidal wind turbine derives its rotary motion from a differential velocity pressure of the air flow acting on the turbine blades. The inner and outer surfaces of each turbine blade result in a constant cross section combined in a uniform longitudinal warp (warp). This arrangement promotes complex additional air flow turbulences within the toroidal displacement.

The vertical axis wind turbine upper rotation velocity is limited to the prevailing wind peripheral velocity, at which there is only minimal torque generated and may be referred to as the “no load rpm”. Any attached mechanism applying a restraint to the turbine rotation, and reducing the turbine velocity in relation to the wind velocity, increases the differential velocity pressure on the turbine blades. This holds until the differential velocity pressure matches the attached machinery pressure demand, in the form of torque “in”, and torque “out” and this is referred to as the “load rpm”. The resulting “Toroidal” vertical axis wind turbine is a low rpm turbine machine developing high torque with practically no noise and no vibrations, requiring practically no maintenance and of relatively low cost construction. Such a toroidal wind turbine machine provides an automatic and effective torque converter between the available wind power and the electrical generator(s). All components are designed for a minimum fatigue life of 120,000 hours which is in excess of 30 years' service life. The currently disclosed vertical axis wind turbine/wind power generator has an efficient toroidal geometry in that it comprises a “doughnut-shaped” rotational channel within which wind activated turbine blades are confined in a stable rotating motion about a vertical axis.

According to one embodiment, at least three, optionally five “aerofoil” or turbine blades travel in the “doughnut-shaped” channel. The turbine blades are aerodynamic, self-starting under low wind speeds and rotate about a central axis of a vertically mounted drive shaft. The drive shaft may be coupled through an epicyclic gearbox to transmit torque directly to an output shaft which may be connected to a device or machine, such as a pump or a high torque electrical generator. In other embodiments a hydraulic transmission converter system could be combined with an efficient low rpm, high torque electrical generator to complete a machine for directly converting wind power to electrical power. The hydraulic transmission converter is auto regulating and enables the generator to convert almost all the wind's power into electricity.

The high torque electrical generator may also be operatively associated and connected with electrical charge storage devices such as accumulators, batteries or capacitors, to store electrical power for which there is no immediate demand. The high torque electrical generator may be optionally integrated into a power grid when generator supply exceeds local demand. The vertical axis wind turbine system's efficiency comes from its increased power occasioned by the optimum differential reduction in air pressure and increased wind velocity flowing across the surface of each turbine blade. The wind pressure that develops causes the back surface of the turbine blades to move (be sucked) into the wind as a result of a negative pressure providing maximum power output.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

Advantages of the generator include its power to size ratio, low noise and lower likelihood of bird strike. It is relatively silent, vibration free, low maintenance and is low cost. It commences producing energy at very low wind speeds (2-3 meters/second) and has an unlimited maximum wind speed, in that it is capable of generating power in high or gale force winds when the larger horizontal axis turbines would require shutting down to avoid potential damage or destruction at dangerous and uncontrollable speeds.

The disclosed vertical axis wind turbine gives optimal and maximum positive drive regardless of wind direction or wind turbulence. Existing horizontal wind generators suffer from constant misalignment due to changes in wind direction. Those horizontal wind generators are unable to automatically self re align to the wind direction and lack the capacity for an instant response to change of wind speed. As a result, during the period of re aligning, power efficiency is reduced, and indeed often a power input to apply braking to limit damage is called for. The presently disclosed vertical axis wind turbine in comparison does not rely on or require re alignment. In part this may be explained due to its toroidal radial symmetry and turbine blade warp geometry always presenting at least part of one turbine blade in a near optimum torque orientation. This turbine blade warp geometry and turbine blade surface configuration offers the capacity to capture wind during both the downwind and upwind travel. The vertical axis wind turbine generator of the present invention operates at relatively low rpm, developing high torque with no noise or vibrations.

The high power to weight ratio allows the turbines according to the present invention to be used in high and low load applications. They are capable of installation on the roofs of buildings in urban areas, all connected to the grid, delivering power where demand is highest. This reduces the need for conventional infrastructure and particularly such hardware as overland transportation lines.

The associated electricity generator and storage facilities will can be sited remote from the actual turbine's location. For example the generating equipment can be placed in another near building, under a roof or ground, rather than underneath or proximate the turbine itself.

The turbine blades cooperate irrespective of whether they are tracking downwind or upwind during rotation. Each turbine blade acts in a similar manner to an aerofoil wing in that there is differential pressure in air-flow over the turbine blade, which experiences a “low pressure” side and a “high pressure” side with a resultant displacement towards the low pressure side. The pressure differential between the high and low pressure surfaces is created by the velocity of the wind interacting with the warped aerofoil shaped turbine blade. This differential can change along the length of each turbine blade as a result of the variation in the angle of attack of the air flow over the turbine blade along the length of the turbine blade due to the inbuilt lengthwise-warp. The observed effect is that the pressure differential drags or sucks the turbine blades into the wind delivering maximum power output. This phenomenon does not occur in known wind turbines. The shape of each turbine blade causes the wind to push the wing on one side of the turbine and creates a quasi-vacuum on the other side which sucks the wings back up into the wind driving the drive shaft. As a result each turbine blade is contributing to torque in each quadrant of rotation. On the upwind side, the turbine blade orientation allows a negative/suction force to exceed upwind drag. Both sides of the turbine blades drive the wind turbine together in the same direction producing a far greater output of mechanical energy than conventional turbines.

According to one embodiment, when five turbine blades are set at 72 degree intervals, the incoming air flow pressure distributes most of the air mass against three turbine blades at any one time with the rear surface of the fourth and fifth turbine blades being dragged forward upwind. The foremost turbine blade acts as a ramp converting the received wind pressure into an upwind rotating flow resulting in drag torque. On the windward side turbine blades (offset at say 120 degrees) generate an opposite downward air flow. These turbine blades combine with a reverse vortex to complete the conversion pressure path. Kinetic energy from the wind is very efficiently captured by the vertical axis wind turbine (toroidal wind turbine) power design which generates a positive torque on both sides of the vertically disposed turbine drive shaft. Turbine power is increased by the angle at which the turbine blades receive airflow, and the tangential path of wind impacting on the turbine blades.

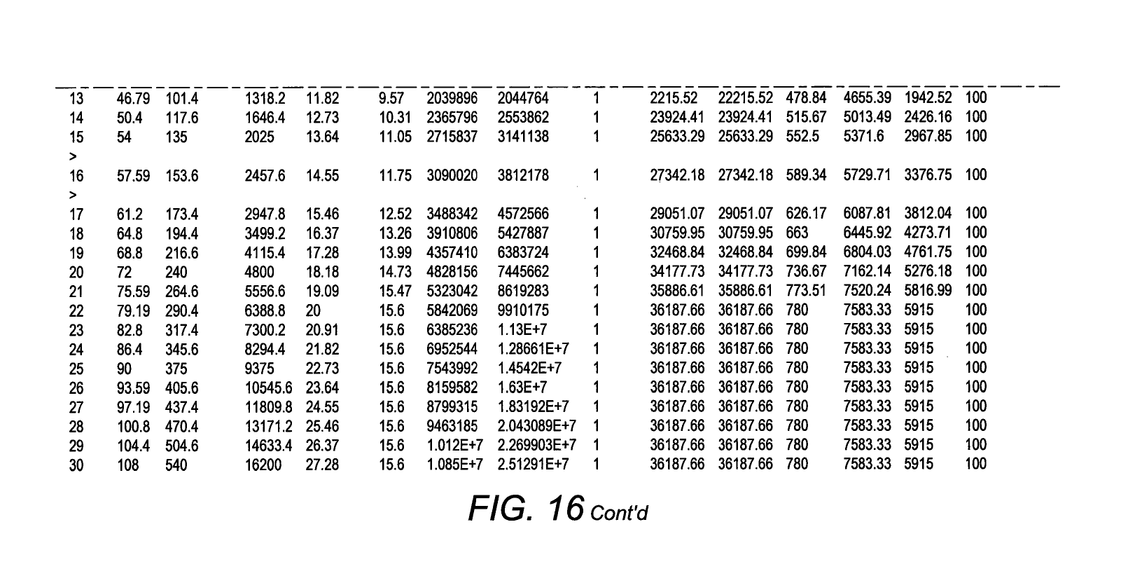

FIG. 14 illustrates the general wind flow 210 on either side of a rotating vertical axis wind turbine 211. Wind pressure on both sides of the vertical axis contributes positively to the rotation of the turbine. The arrows 212 and 213 on opposite sides of the axis 214 rotate the turbine in the same direction. Except for the unique design of the warped/warped aerofoil wings with their compound helix shape, the lift torque arrow 213 (bottom arrow) would normally tend to be pushed by the wind in the opposite direction against the torque generated in the windward quadrants of rotation. This would normally reduce the efficiency of the turbine. However, in the presently disclosed vertical axis wind turbine, the turbine blades when in the upwind quadrants rotation contribute to the positive torque generated on the downwind side. The disclosed vertical axis wind turbine causes a simultaneous ‘pull’ and ‘push’ effect so that the side of the turbine shaft which is turning into the wind (that is against the flow of the wind, marked in the direction of arrow B) contributes positively to the rotation of the turbine. To use a sailing analogy, the toroidal wind turbine harnesses the wind's power with a combination of ‘spinnaker’ and ‘jib’ actions so that the turbine blades (sails) of both sides of the vertical axis are contributing to the same direction of rotation and in combination are able to extract far more power from the wind than any other system. Due to the turbine blade geometry and its movement during rotation about the drive shaft of the turbine, the wind power input of the turbine is now the total of the two arrows 212 and 213. For all other turbines the power output would be bottom arrow subtracted from the top arrow.

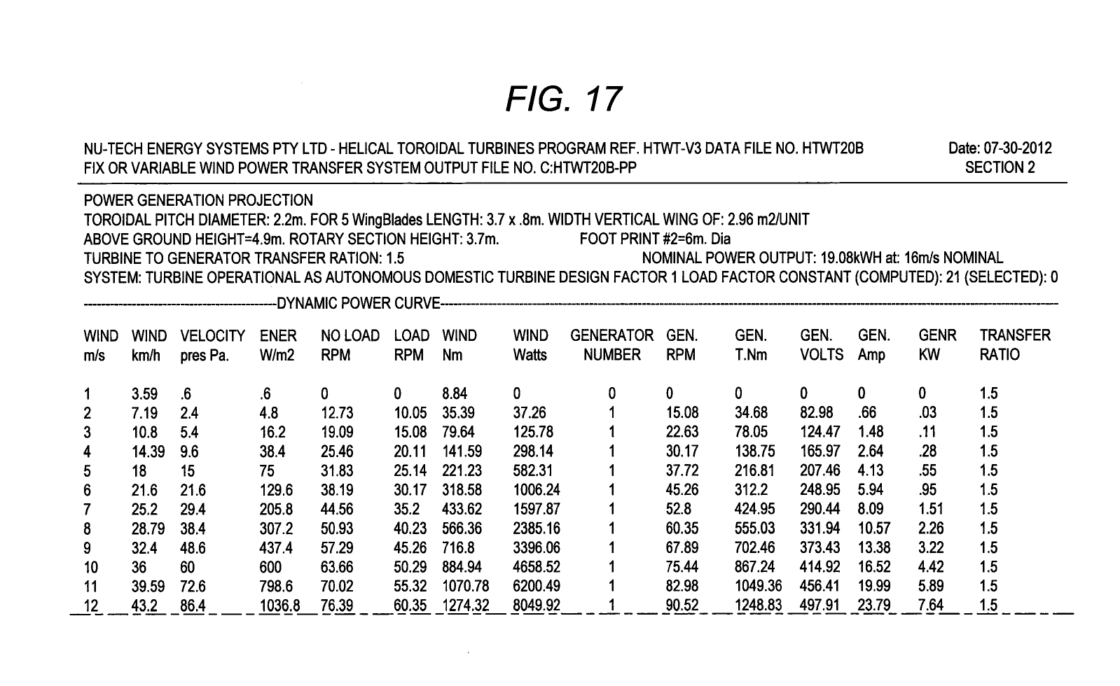

FIG. 15 shows a schematic model shape of a rigid turbine blade 230 in finite element analysis view and demonstrating a helical warp according to a preferred embodiment. Each individual turbine blade may comprise a single warped or warped aerofoil type turbine blade which may be manufactured from one mould. Turbine blade segments may be according to one embodiment, moulded from fibreglass/carbon-fibre reinforced resin composites, similar to those used in wings of modern aircraft Fibreglass/carbon-fibres resin composites provide a high strength to weight ratio. Each turbine blade may be about 2.7 metres high and 0.75 metres wide at its widest point and at that size can weigh as little as 30 kgs. Turbine blade 230 has a turbine blade body 231, a first end 232 and second end 234. Turbine blade body 231 may be formed in the shape of a helix or with a warp but at any point along its longitudinal length it retains a generally aerofoil shape in section. Thus turbine blade 230 combines a wing cross sectional shape with an inbuilt helix which allows the turbine blade to maximise wind capture. Wind capture may be altered or improved by changing the turbine blade dimensions, shape and spacing relative to the vertical drive axis.

In each vertical axis wind turbine generator apparatus each turbine blade presents its compound pitch and warp shape to the wind as it revolves around the vertical axis drive shaft. Each turbine blade also has a circular-elliptical shape with extended planes resulting in a spatial wind trap. According to one embodiment, turbine blade 230 is manufactured from five moulded segments that together form the turbine blade 230. Each turbine blade 230 is attached to the turbine at regular 72 degree intervals which present the same, identical facade to the wind. The turbine blades 230 capture the wind and operate irrespective of wind direction to efficiently convert the wind's kinetic energy into electrical energy. In this way the disclosed vertical axis wind turbine apparatus offers a toroidal wind turbine “TWT” power system which can produce different and scalable power capacities. For example, turbines can be rated to produce 10, 15, 30 and 100 kilowatts respectively. The vertical axis wind turbine (TWT) may commence generating power at wind speeds of less than 2 meters/second (‘m/s’). Most other existing wind turbine technologies require wind speeds in the order of at least 5-6 m/s simply to overcome inertia in the wind turbine system.

Non limiting examples of the turbine power and configurations are identified below. As an example, a small five turbine blade version of the wind generator could deliver from around 10 to 15 kilowatts in power. The height in this exemplary case would be approximately 2,700 mm and each turbine blade would sit approximately 790 mm off the ground or base support. Overall height of this illustrative embodiment would be about 3,490 mm and the total weight would be less than one tonne fully assembled. A higher rated embodiment capable of producing 30 kw of power would stand at 5,425 mm high overall with turbine blades of 4,400 mm in height and elevated about 1,025 mm off the ground.

Another high rated embodiment producing 100 kw of power, would stand 7,843 mm in height. Its turbine blades would be 7,000 mm in height and about 4,025 mm off the ground. The total height of this embodiment of a vertical axis wind turbine generator may be about 11,506 mm.

Further advantages of the present invention over the known art include the following. The disclosed vertical axis wind turbine or Toroidal Wind Turbine (TWT) is far more efficient than any Horizontal Wind Turbine (HWT) because it uses the volumetric surface area of each turbine blade to drive the turbine/generator instead of just the surface area of the leading edge arc of the HWT propeller blades. In the turbine blades of the present invention, on the upwind side, a negative pressure creates a force drawing the turbine blades upwind and counteracts the drag force. The TWT is lighter than the prior art HWT structures as less materials are used. Typically a horizontal wind turbine can stand 35 meters tall and weigh as much as 120 tonnes. Also light structures require less foundations. The presently disclosed vertical axis wind turbine or TWT allows for remote generating equipment separated from the turbine blade location, this provides easy accessibility for maintenance. The toroidal wind turbine has environmental advantages including reduction of bird strike as birds can see the rotating structure whereas a horizontal wind turbine can be difficult to see during rotation of turbine blades in a vertical plane. Another advantage of the presently disclosed vertical axis wind turbine is that individual vertical axis wind turbines when placed side by side do not interrupt wind flow to an adjacent vertical axis wind turbine. This allows a higher concentration of wind turbines in a given area and considering their relatively small footprint, less area is taken up for a higher power generation. On a large scale, this reduces or eliminates the need for grid infrastructure with the attendant reduction in maintenance and set up costs. Reduced weight and lower maintenance lead to lower costs per kilowatt compared to the prior art wind turbines. Furthermore the toroidal wind turbine does not generate a pressure wave downstream of wind flow as a result of which it is relatively silent. The warp in the turbine blade allows that no matter the orientation of the turbine blade relative to wind flow, it provides a positive torque.

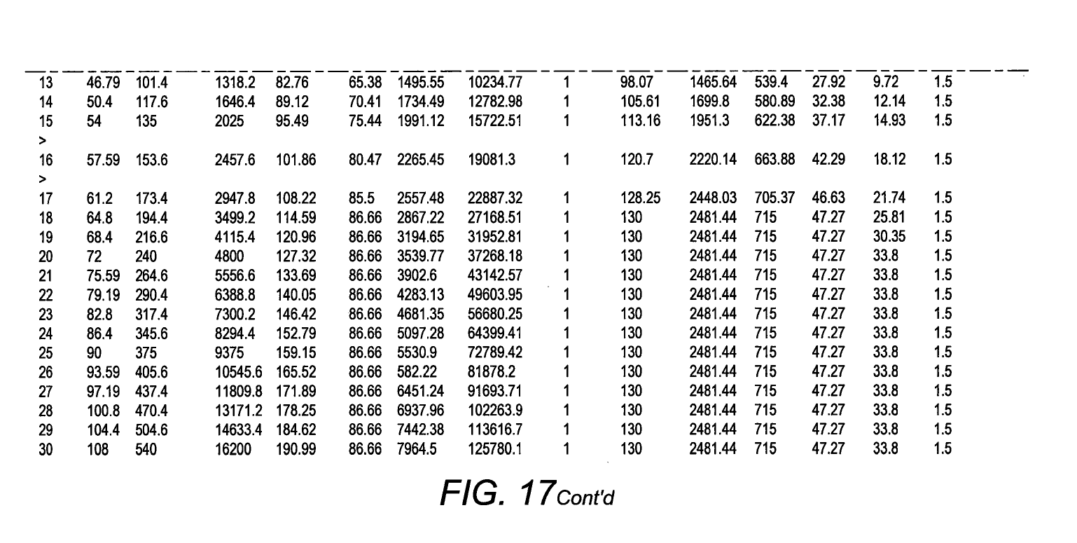

FIGS. 16 and 17 show two tables of results of operation of a vertical axis wind turbine or toroidal wind turbine as disclosed herein. Each table shows different sized generators and the results for the power curve. The larger of the two in FIG. 16, (80×6 m) show higher output than the smaller generator (3.7×0.8 m) results in FIG. 17. For the same wind velocity the larger the generator the higher the output, even though for the larger generator the upwind drag is potentially higher.

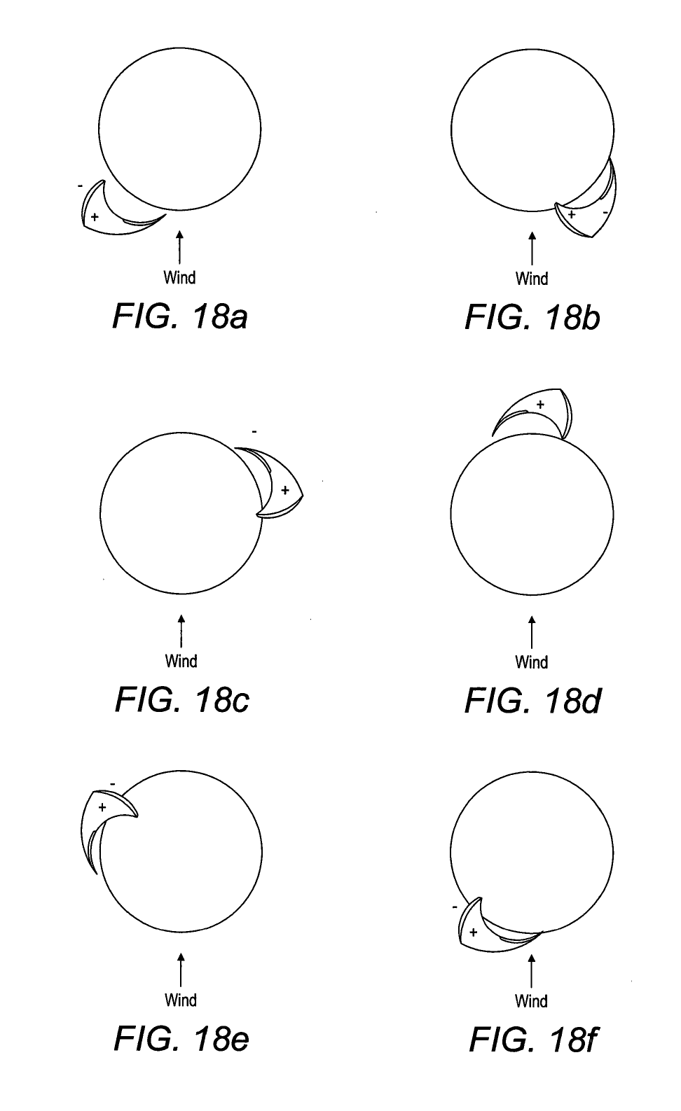

FIG. 18 shows schematically and in successive illustrations, the major windload velocity pressure area on a toroidal wind turbine machine as disclosed herein. Only one of the multiple turbine blades is illustrated, and shows a “+” or “−” to indicate pressure effect upon the turbine blade surfaces. Wind effect upon each turbine blade having a lengthwise warp continues to provide positive torque as the turbine blade advances around a toroidal path represented by the circle shown in the diagram. It will be understood that the other turbine blades act similarly but are omitted in this figure for explanation purposes only.

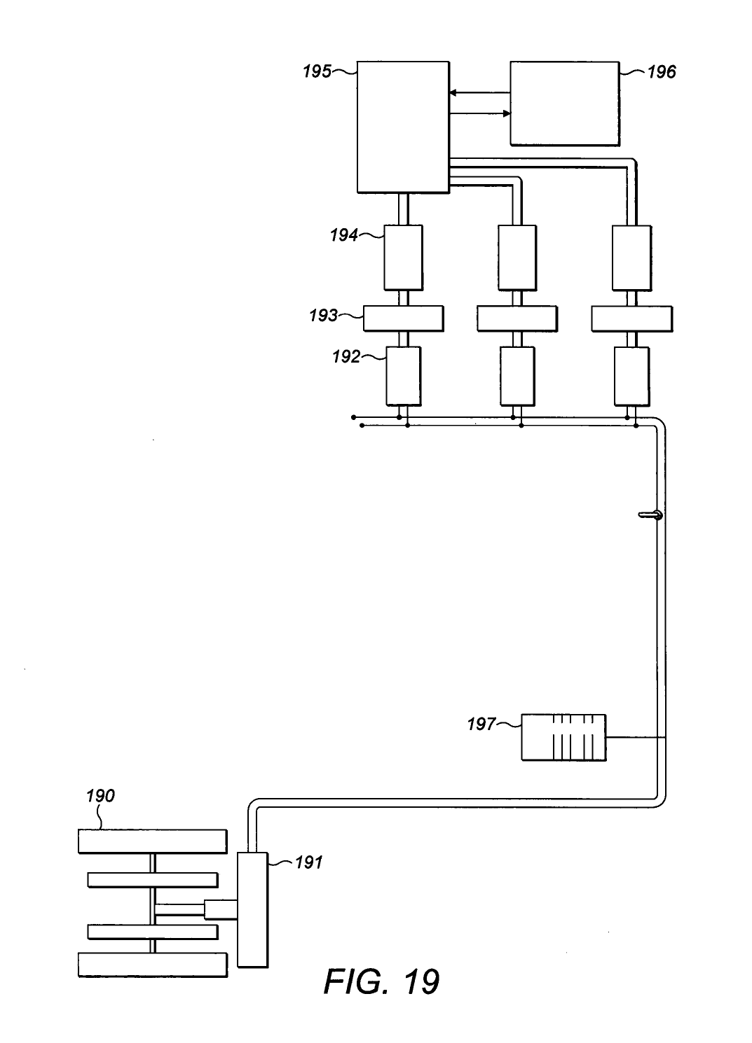

FIG. 19 represents an optional hydraulic power transmission system for transmitting torque generated by the toroidal vertical axis wind turbine 190 to a hydraulic pump 191, connected to multiple outputs including for example variable speed hydraulic motors 192. The hydraulic motors may be coupled to an optional gear box 193 in order to power multiphase electrical generators 194, capable of being selectively or collectively operated according to demand. Devices 195 such as DC-AC inverters and AC-DC converters may be included in the system. The electrical output from the generators 194 may be stored in an electrical charge storage device such as a battery 196, accumulator, storage cell, capacitor based charge storage device and the like. Optionally the electrical output from the generators 194 may be conducted to a local minigrid or main grid. A pressurised hydraulic reservoir or accumulator 197 is connected with the pump to deliver fluid and receive low pressure return.

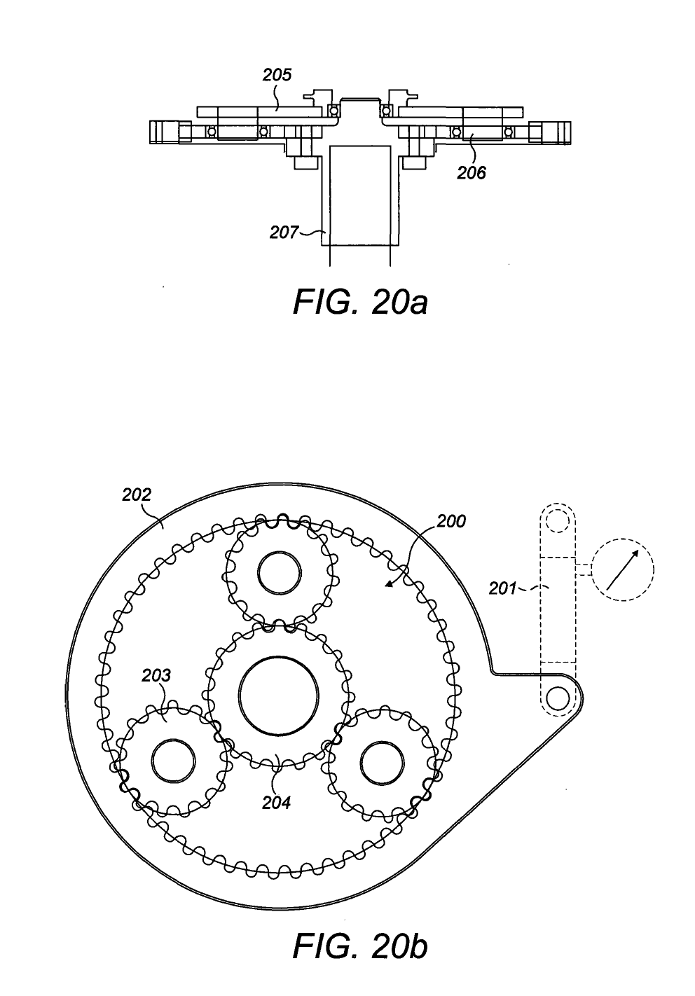

FIGS. 20a and 20b illustrate an epicyclic gear transmission 200 with associated torque monitoring sensor 201. The torque monitoring sensor 201 is mounted on a static ring gear 202. Three epicyclic gears 203 transmit torque to a central drive gear 204. A mounting plate 205 and bearings 206 can be provided to allow the vertically mounted shaft to be connected to the epicyclic gear transmission allowing transfer of torque from the vertically mounted shaft to an output shaft 207 for a device or a machine, such as for example, a fluid pump or an electricity generator.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. Apparatus comprising a shaft mounted vertically in a support providing for axial rotation of the vertically mounted shaft, and a plurality of vertically oriented elongate turbine blades mounted upon the vertical shaft, each turbine blade having a length between opposite free ends, and a length-wise warp which extends along at least a substantial part of the length of the turbine blade between the opposite free ends, and wherein the turbine blade has a warp width between a leading edge and a trailing edge forming a turbine blade surface capable of creating a pressure differential in an air flow over the turbine blade surface.

2. Apparatus as claimed in claim 1, wherein the length-wise warp is such that opposite ends of each turbine blade are offset within the range 30-180 degrees out of phase relative to a longitudinal axis through the turbine blade.

3. Apparatus as claimed in claim 1, wherein the length-wise warp in each turbine blade is a helical warp.

4. Apparatus as claimed in claim 1, wherein the turbine blade has the shape of a warped aerofoil.

5. Apparatus as claimed in claim 1, wherein the turbine blade has a convex surface on one side of the turbine blade.

6. Apparatus as claimed in claim 1, wherein the turbine blade has a concave surface on one side of the turbine blade.

7. Apparatus as claimed in claim 1, wherein the turbine blade provides a positive torque during rotation of the turbine blade about the vertically mounted shaft throughout four quadrants of rotation.

8. Apparatus as claimed in claim 1, wherein each turbine blade is retractably mounted upon a movable arm attached to the vertically mounted shaft.

9. Apparatus as claimed in claim 8, wherein the arm is a radial moment arm which transmits torque to the vertically mounted shaft.

10. Apparatus as claimed in claim 1, wherein each turbine blade is linked via a mechanical or hydraulic arm to a position controller which actuates the mechanical or hydraulic arm in order to actively change the position of a turbine blade.

11. Apparatus as claimed in claim 1, wherein a linear actuator is arranged between a turbine blade and the vertically mounted shaft to provide controlled positioning of the turbine blade.

12. Apparatus as claimed in claim 1 wherein the vertically mounted shaft is connected to an epicyclic gear transmission allowing transfer of torque from the vertically mounted shaft to a device or a machine.

13. Apparatus as claimed in claim 12, wherein the device or machine is a fluid pump or an electrical generator.

14. A toroidal vertical axis wind turbine apparatus comprising a shaft vertically mounted in a support providing for rotation of the vertically mounted shaft about its longitudinal axis, and a plurality of vertically oriented elongate turbine blades, each vertically oriented elongate turbine blade having a length and a width, and a length-wise warp which extends along at least a substantial part of the length of the turbine blade, wherein each vertically oriented elongate turbine blade is mounted upon the vertically mounted shaft by support arms such that the vertically oriented elongate turbine blades are mutually spaced and outwardly spaced from the vertically mounted shaft such that when contacted by wind, the plurality of vertically oriented elongate turbine blades move around a toroidal path and cause axial rotation of the vertically mounted shaft.

15. An electrical power system comprising an apparatus as claimed in claim 1, operatively connected with an electricity generator which is electrically connected with at least one of an inverter, electrical switchgear, electrical charge storage devices and a power grid.
